(19) United States
(12) Patent Application Publication
(10) Pub. No.: US 2023/0278149 A1
(43) Pub. Date: Sep. 7, 2023

(54) Modular Valve Assembly and Methods of Making the Same

(71) Applicant: Cyrus Shank Corporation, Aurora, IL (US)

(72) Inventors: Frank Kruppe, Aurora, IL (US); Cody Hambly, Aurora, IL (US); Krzysztof Chelminski, Aurora, IL (US)

(21) Appl. No.: 18/117,846

(22) Filed: Mar. 6, 2023

Related U.S. Application Data
(60) Provisional application No. 63/317,333, filed on Mar. 7, 2022.

(51) Int. Cl. B23P 15/00; F16K 27/02; F16K 27/00

(52) U.S. Cl. CPC B23P 15/001; F16K 27/0209; F16K 27/003

(57) ABSTRACT

A method of making a modular valve assembly. A first housing member and a second housing member are provided, and the first housing member is joined to the second housing member to form a unitary housing. A valve component opening is formed in the unitary housing, and the valve component opening is sized to receive a valve component. An inlet passageway is formed in the unitary housing. The inlet passageway communicates that the valve component opening. An outlet passageway is formed in the unitary housing. The outlet passageway communicates with the valve. component opening. A valve component is placed in the valve component opening.

### RELATED APPLICATION DATA

This application claims priority benefit to U.S. provisional application Ser. No. 63/317,333, the disclosure of which is incorporated by reference herein.

### BACKGROUND OF THE INVENTION

The present disclosure is directed to a modular valve assembly and methods of making the same.

### SUMMARY

One aspect of the disclosure is a method of making a modular valve assembly. A first housing member and a second housing member are provided, and the first housing member is joined to the second housing member to form a unitary housing. A valve component opening is formed in the unitary housing, and the valve component opening is sized to receive a valve component. An inlet passageway is formed in the unitary housing. The inlet passageway communicates with the valve component opening. An outlet passageway is formed in the unitary housing. The outlet passageway communicates with the valve. component opening. A valve component is placed in the valve component opening.

Further features and advantages, as well as the operation, are described in detail below with reference to the accompanying drawings.

### BRIEF DESCRIPTION OF THE DRAWINGS

FIG. 1 is a front view of a modular valve assembly.

FIG. 2 is a left side view of the modular valve assembly of FIG. 1.

FIG. 3 is a right side view of the modular valve assembly of FIG. 1.

FIG. 4 is a set of cross sectional views of the modular valve assembly of FIG. 1.

FIG. 5a is an isometric view of housing members of an embodiment of the modular valve assembly of the modular valve assembly of FIG. 1

FIG. 5b is an isometric view of housing members of another embodiment of the modular valve assembly of the modular valve assembly of FIG. 1

FIG. 5c is an isometric view of housing members of yet another embodiment of the modular valve assembly of the modular valve assembly of FIG. 1

FIG. 6 is a flow diagram of an embodiment of a method of manufacturing the modular valve assembly of FIG. 1.

FIG. 7 shows valve components that may be used with the modular valve assembly of FIG. 1.

FIG. 8 shows valve components that may be used with the modular valve assembly of FIG. 1.

FIG. 9 shows valve components that may be used with the modular valve assembly of FIG. 1.

FIG. 10 shows valve components that may be used with the modular valve assembly of FIG. 1.

FIG. 11 shows another embodiment of a left housing member in multiple views.

FIG. 12 shows another embodiment of a middle housing member in multiple views.

FIG. 13 shows another embodiment of a right housing member in multiple views.

FIG. 14 is a cross-sectional view of modular valve assembly comprising the left housing member of FIG. 11, the middle housing member of FIG. 12, and the right housing member of FIG. 13 with additional valve components installed thereon.

### DETAILED DESCRIPTION

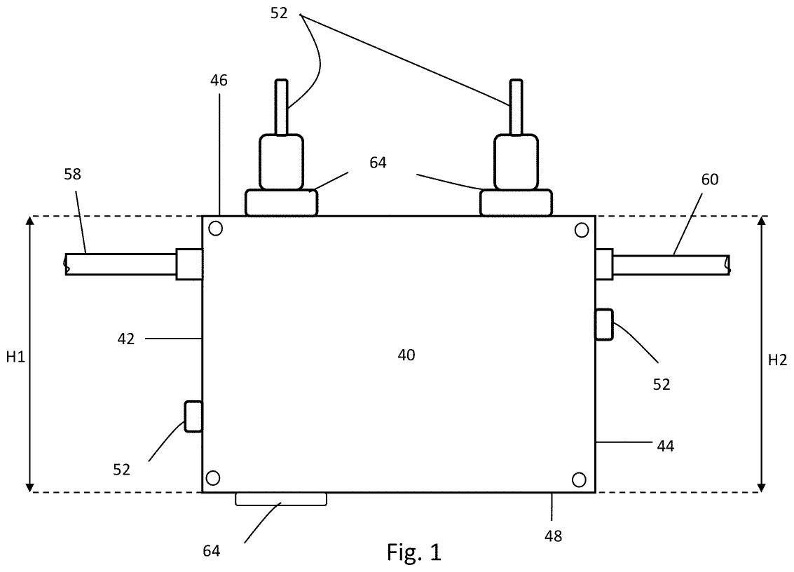

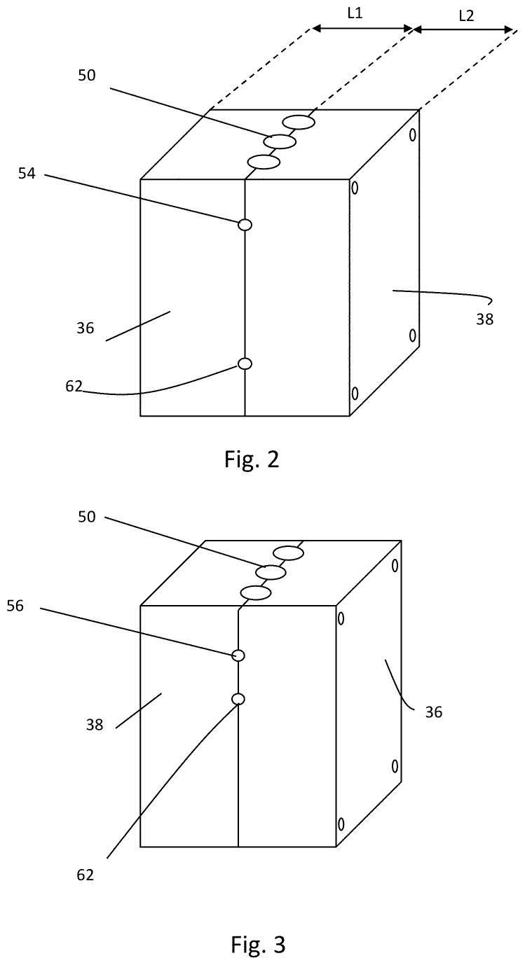

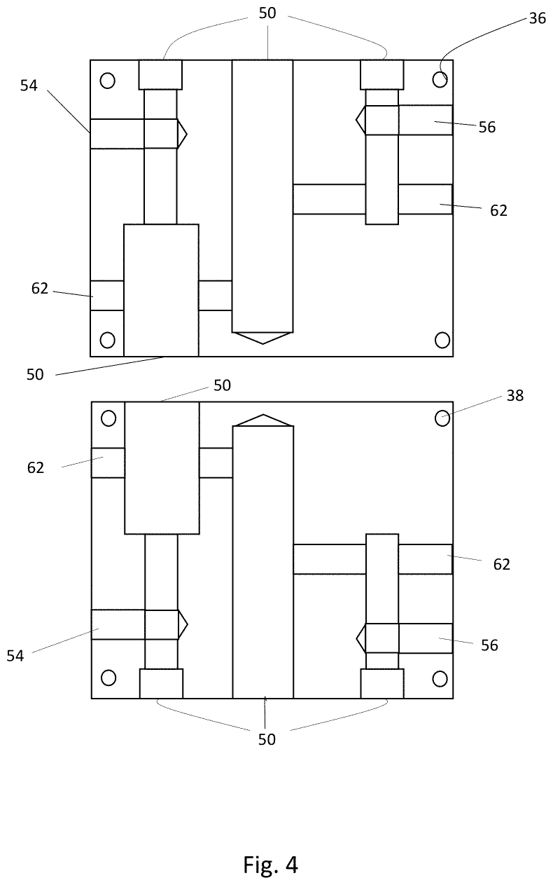

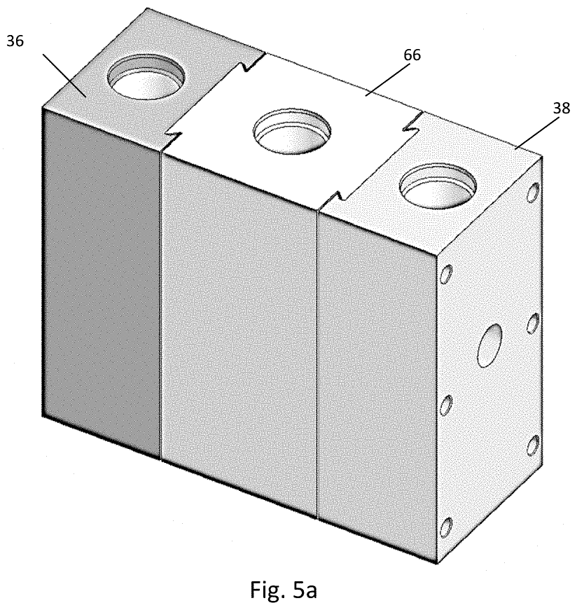

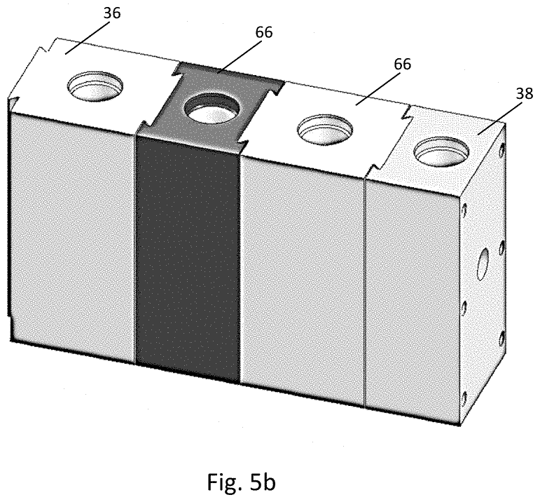

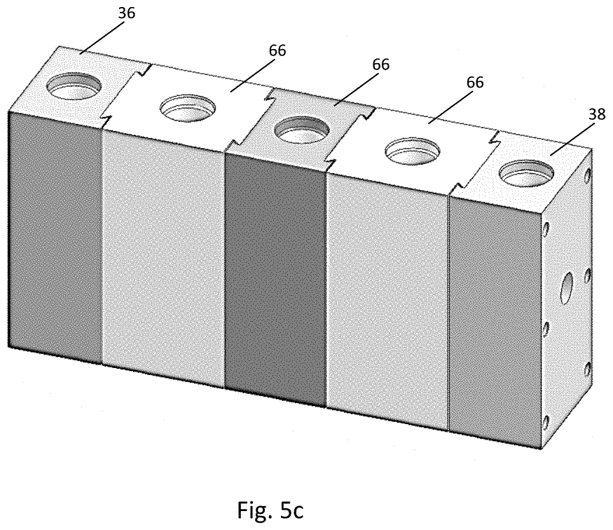

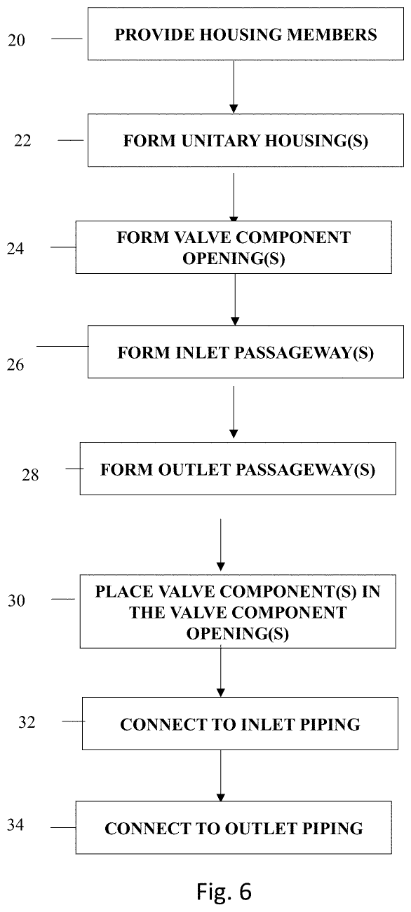

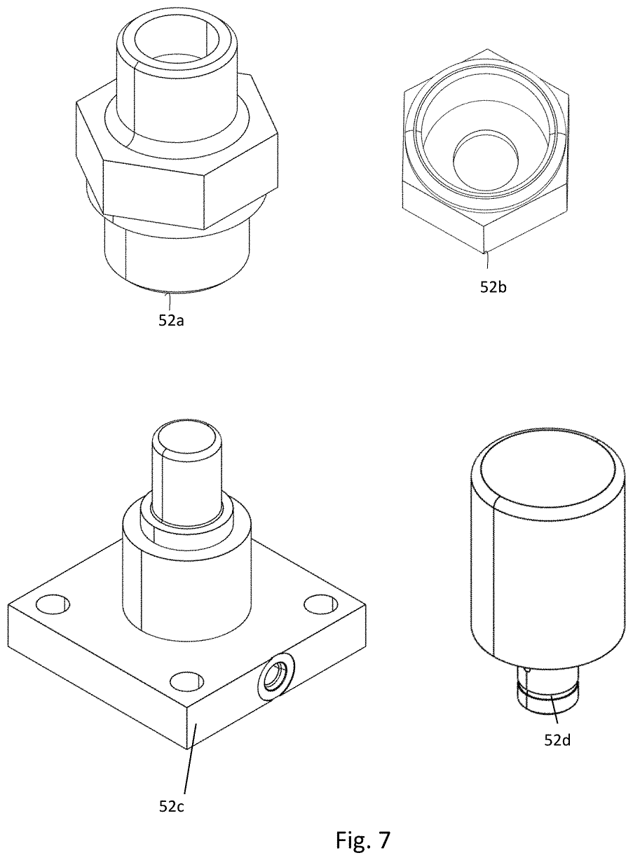

FIGS. 1-5c show a modular valve assembly, which is described in detail below. FIG. 6 is a flow diagram of an embodiment of a method of manufacturing a modular valve assembly, including that shown in FIGS. 1-5c. Referring to reference number 20, the method comprises providing a first housing member 36 and a second housing member 38. This step may include providing the first housing member 36 having a length L₁ and a height H₁ and providing the second housing member 38 having a length L₂ and a height H₂. The length and height L₁, H₁ of the first housing member 36 may be dimensioned to match the length and height L₂, H₂ of the second housing member 38. The first and second housing members 36, 38 may be provided as a monolithic block of material. Additionally, the first and second housing members 36, 38 may comprise various materials including aluminum, steel, or like materials. The first and second housing members 36, 38 may be rectangular in shape.

Referring to reference number 22, the method further comprises joining the first housing member 36 to the second housing member 38 to form a unitary housing 40. The unitary housing 40 may have first and second opposite end surfaces 42, 44 spaced apart by the first and second housing member lengths L₁, L₂. Similarly, the unitary housing 40 may have first and second side surfaces 46, 48 spaced apart by the first and second housing member heights H₁, H₂. The first and second housing members 36, 38 may have complementary and interlocking geometry to allow the first and second housing members to be joined together to form the unitary housing 40. For instance, the first and second housing members 36, 38 may have a system of tabs and grooves, alignment and/or locking pins or dowels, and/or cam engagement fasteners for joining the first and second housing members together. In addition to or in the alternative, joining the first housing member 36 to the second housing 38 member to form the unitary housing member 40 may be accomplished by slidably connecting the first housing member to the second housing member. For example, a matching dovetail may be formed in the first and second housing members, and the matching dovetail may be used to slidably connect the first housing member 36 to the second housing member 38. The dovetail may be formed to extend from one end surface 42 to an opposite end surface 44. The dovetail may be formed to extend from one side surface 46 to an opposite side surface 48. Multiple dovetails may be provided on opposite ends 42, 44 or sides 46, 48 of the first and second housing members 36, 38, depending on the sizes of the first and second housing members. In addition to or in the alternative, mechanical fasteners may also be used to join the first and second housing members 36, 38 together.

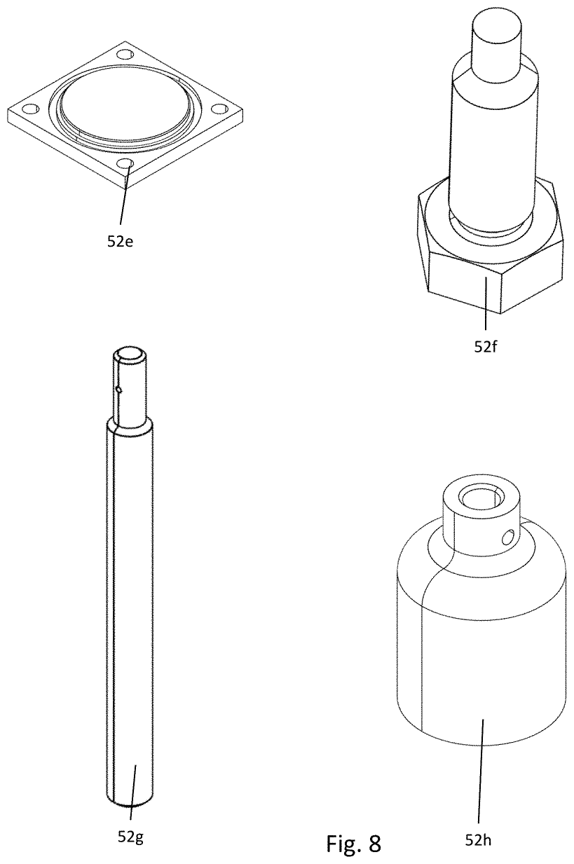

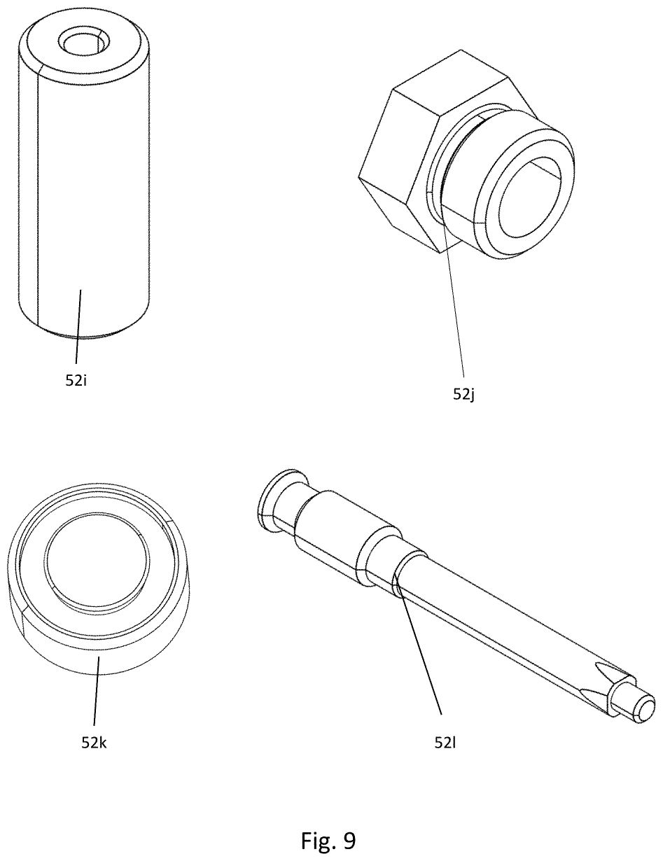

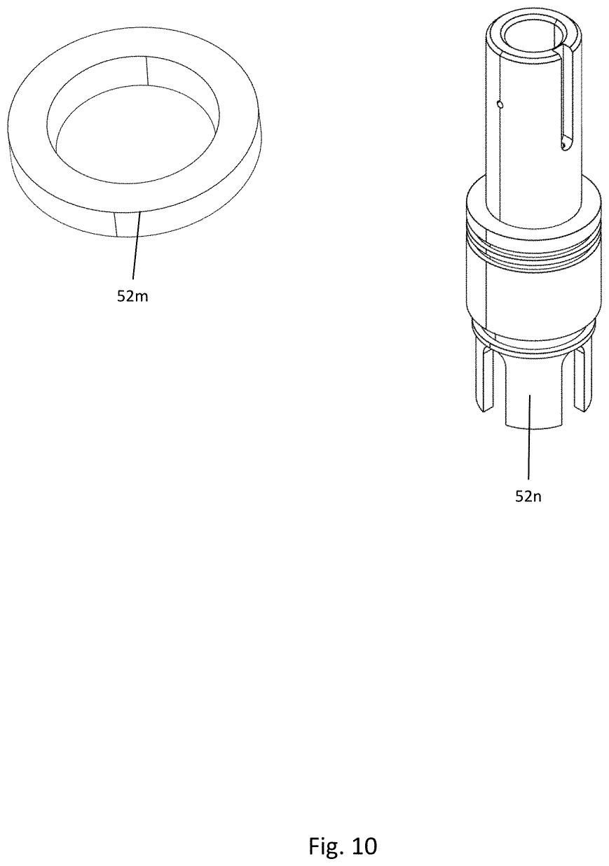

Referring to reference number 24, the method further comprises forming a valve component opening 50 in the unitary housing 40. The valve component opening 50 may be sized to receive a valve component 52. As used herein, “valve component” means and refers to a solenoid, strainer, relief valve, check valve, valve body, spring, magnet, lead screw, plug, cartridge, filter, valve seat, or the like. Such components are shown in FIGS. 7-10. FIGS. 7-10 show additional valve components including a bonnet 52a, cap 52b, cartridge 52c, core 52d, cover strainer 52e, guide 52f, lead screw 52g, magnet 52h, nut 52i, plug 52j, seat 52k, stem 52l, PTFE seat 52m, and V port 52n. As shown in the drawings, the valve component opening 50 may be formed in one of the first and second side surfaces 46, 48 of the unitary housing 40. In addition to or in the alternative, the valve component opening 50 may be formed in one of the first and second end surfaces 42, 44 of the unitary housing 40. Forming the valve component opening 50 may include forming a threaded connection that is adapted and configured to receive a threaded member 64, which may be integral to the valve component or may be used to locate and the mount the valve component in the valve component opening. The threaded member 64 may allow for adjustment of the valve component in the valve component opening.

Referring to reference number 26, the method further comprises forming an inlet passageway 54 in the unitary housing 40. The inlet passageway 54 may communicate with the valve component opening 50. As shown in the drawings, the inlet passageway 54 may be formed in one of the first and second end surfaces 42, 44 of the unitary housing 40. The inlet passageway 54 may also be formed in one of the first and second side surfaces 46, 48 of the unitary housing 40. The inlet passageway may be created by forming a first blind hole through one of the first and second end surfaces 46, 48 of the unitary housing 40, and a second blind hole through one of the first and second side surfaces. The first blind hole and the second blind hole may intersect to form the inlet passageway 54. The second blind hole may then have a plug installed to seal the second blind hole. The inlet passageway 54 formation process may also include forming a threaded connection that is adapted and configured to connect to external piping.

Referring to reference number 28, the method further comprises forming an outlet passageway 56 in the unitary housing 40. The outlet passageway 56 may communicate with the valve component opening 50. The outlet passageway 56 may be formed in the other of the first and second end surfaces 42, 44 of the unitary housing, which corresponds to the end surface opposite the end surface in which the inlet 54 passageway is formed. The outlet passageway 56 may also be formed in one of the first and second side surfaces 46,48 of the unitary housing 40. The outlet passageway 56 may be created by forming a first blind hole through hone of the first and second end surfaces 42, 44 of the unitary housing, and a second blind hole through hone of the first and second side surfaces 46, 48. The first blind hole and the second blind hole may intersect to form the outlet passageway 56. The second blind hole may then have a plug installed to seal the second blind hole. The outlet passageway formation process may also include forming a threaded connection that is adapted and configured to connect to external piping.

Referring to reference number 30, the method further comprises placing a valve component 52 in the valve component opening. This step may include separating the first and second housing members 36, 38. Then, the valve component 52 may be installed in the valve component opening 50. The valve component 52 may be mounted and located as needed in the valve component opening so as to cooperate with the inlet passageway 54 and/or outlet passageway 56. For instance, when the valve component 52 comprises a valve with a valve body, the valve component may be mounted and located in the valve component opening 50 so the valve body is movable to sealingly engage a seat of the inlet passageway 54. After the valve component 52 is located and mounted in the valve component opening 50, the first and second housing members 36, 38 may be rejoined to form the unitary housing 40. Placing the valve component 52 in the valve component opening 50 may also be accomplished by securing the valve component in the unitary housing 40 with the threaded member 64 formed in the valve opening. In addition to or in the alternative, the valve component 52 may be mounted and located in the valve component opening 50 by inserting the valve component in the valve component opening and then sealing the valve component opening with a plug or access disk mechanical joined to the unitary housing 40.

Referring to reference number 32, the method may further comprise connecting the inlet passageway 54 to inlet piping 58.

Referring to reference number 34, the method may further comprise connecting the outlet passageway 56 to outlet piping 60.

The steps referenced in reference numbers 24-30 may also be employed to form one or more further valve component opening(s) 50 in the unitary housing 40 and to install one or more further valve component(s) 52 in the further valve component opening(s). Also, one or more secondary passageway(s) 62 may be formed in the unitary housing 40. The one or more secondary passageway(s) 62 may communicate with the valve component opening 50 and the one or more further valve component opening(s) 50. In one example, the outlet passageway 56 may be in communication with the valve opening 50 via the further valve opening 50 and the secondary passageway 62. In another example, the inlet passageway 54 may be in communication with the valve opening 50 and the further valve opening 50 via the secondary passageway 62. Forming the secondary passageway 62 may include forming the secondary passageway in one of the first and second end surfaces 42, 44 of the unitary housing 40. This may be accomplished by forming the secondary passageway 62 as a blind hole through one of the first and second end surfaces 42, 44 of the unitary housing 40. A plug may then be used to seal the blind hole of the secondary passageway 62 at the first and second end surfaces 42, 44 of the unitary housing.

The steps referenced in reference numbers 20-34 may apply equally to a process involving additional housing members 66 (such as a third and fourth housing member). In such an instance, the pairs of additional housing members are provided in accordance with reference number 20, are joined to form a further unitary housing in accordance with reference number 22, and have components formed and/or connected in accordance with steps 24-34. Thus, the discussion of reference numbers 20-34 applies equally to additional housing members and unitary housings. The further unitary housing may be connected end surface to end surface and/or side surface to side surface. In one example, unitary housings of the type shown in FIGS. 1-5c may be connected end surface to end surface such that the outlet passage of the first in series unitary housing is aligned with the inlet passageway of the further, next in series, unitary housing. In such a circumstance, the inlet piping connection discussed with respect to reference number 32 would connect to the inlet passageway of the unitary housing, and the outlet piping connection discussed with respect to reference number 32 would connect to the outlet passageway of the further unitary housing.

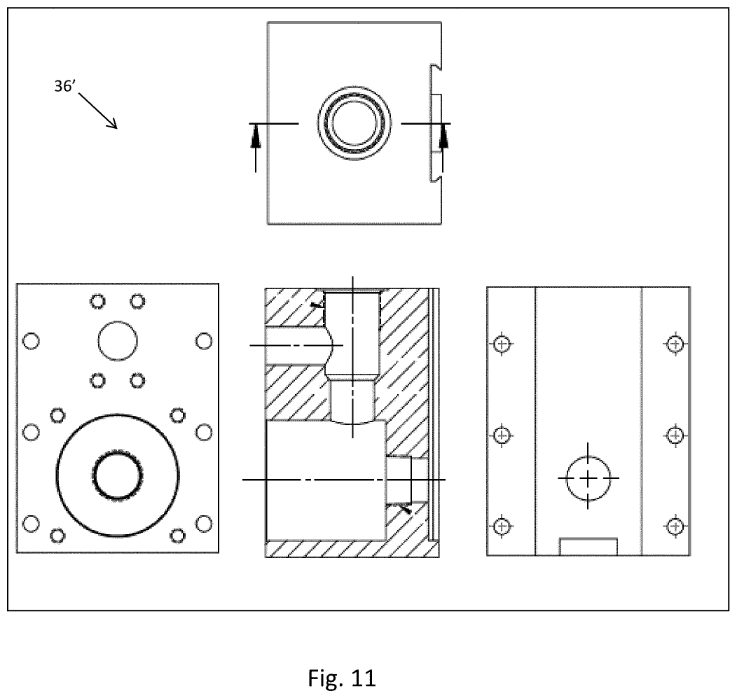

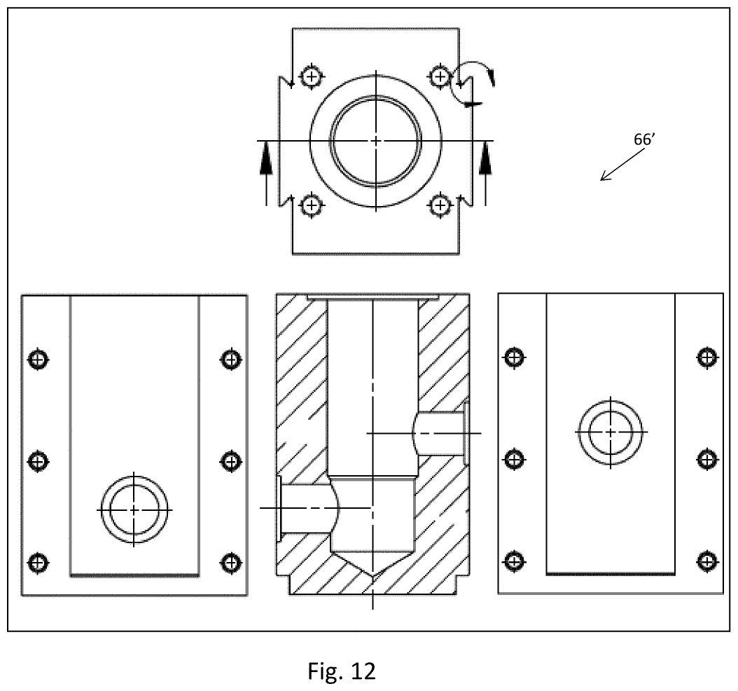

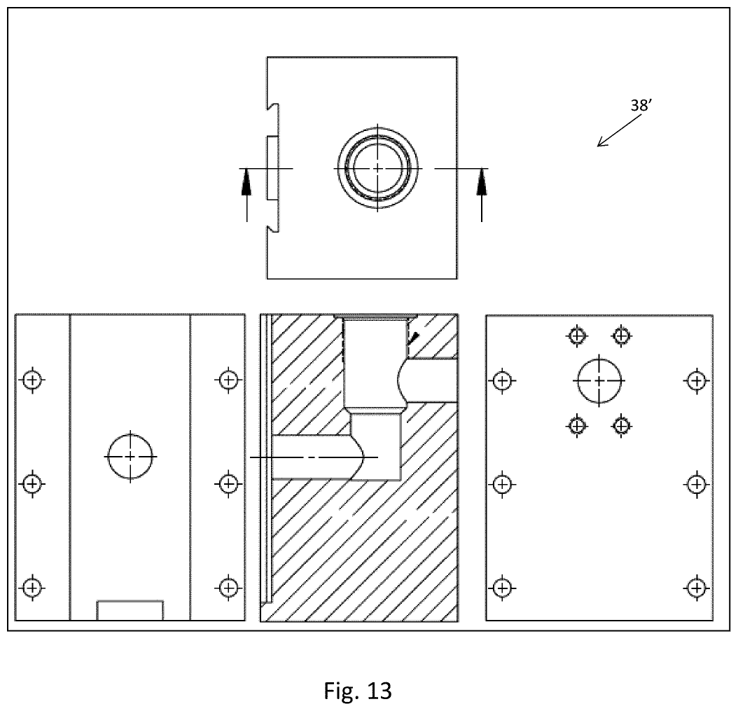

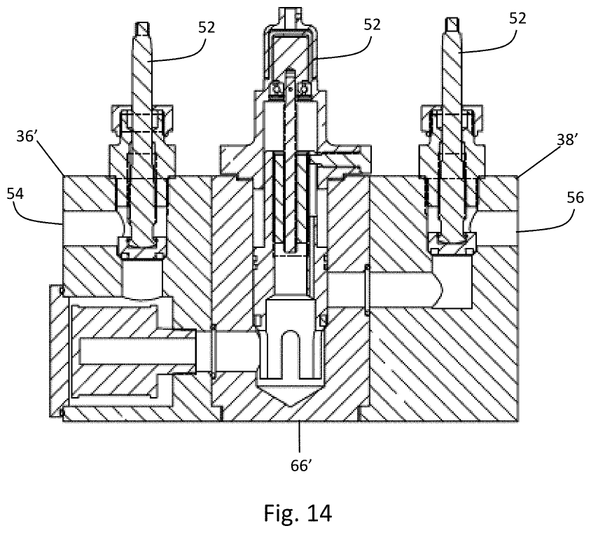

FIGS. 11-14 provide another example of a modular valve assembly using a left housing member 36′, a middle housing member 66′, and a right housing member 38′. Each of the housing members is joined together using a dovetail arrangement and mechanical fasteners. Each of the housing members has a valve member for controlling flow through a respective passageway of the housing member and the modular valve assembly as a whole.

In view of the foregoing, it should be appreciated that the invention has several advantages over the prior art.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method comprising:
providing a first housing member and a second housing member;
joining the first housing member to the second housing member to form a unitary housing;
forming a valve component opening in the unitary housing, the valve component opening being sized to receive a valve component;
forming an inlet passageway in the unitary housing, the inlet passageway communicating with the valve component opening;
forming an outlet passageway in the unitary housing, the outlet passageway communicating with the valve component opening; and
placing a valve component in the valve component opening.

2. The method of claim 1 wherein the step of providing the first and second housing member includes:
providing the first housing member having a length and a height; and
providing the second housing member having a length and a height;
wherein the first housing member length and height is dimensioned to match the second housing member length and height.

3. The method of claim 2 wherein the step of joining the first housing member to the second housing member to form the unitary housing includes:
forming the unitary housing having first and second opposite end surfaces spaced apart by the first and second housing member lengths;
wherein the unitary housing has first and second side surfaces spaced apart by the first and second housing member heights.

4. The method of claim 1 wherein the valve component is at least one of a solenoid, strainer, relief valve, a check valve, a valve body, a spring, a magnet, a lead screw, a plug, a cartridge, a filter, a seat.

5. The method of claim 2 wherein the step of joining the first housing member to the second housing member to form a unitary housing includes slidably connecting the first housing member to the second housing member.

6. The method of claim 5 further comprising forming a matching dovetail in the first and second housing members and slidably connecting the first housing member to the second housing member.

7. The method of claim 3 wherein the step of forming the valve opening includes forming the valve opening in one of the first and second side surfaces of the unitary housing.

8. The method of claim 3 wherein the step of forming the inlet passageway includes forming the inlet passageway in one of the first and second end surfaces of the unitary housing and the step of forming the outlet passageway includes forming the outlet passageway in the other of the first and second end surfaces of the unitary housing.

9. The method of claim 1 further comprising connecting the inlet passageway to inlet piping and connecting the outlet passageway to outlet piping.

10. The method of claim 1 further comprising:
providing a third housing member and a fourth housing member;
joining the third housing member to the fourth housing member to form a further unitary housing;
forming a valve component opening in the further unitary housing, the valve component opening being sized to receive a valve component;
forming an inlet passageway in the further unitary housing, the inlet passageway communicating with the valve component opening;
forming an outlet passageway in the further unitary housing, the outlet passageway communicating with the valve component opening; and
placing a valve component in the valve component opening of the further unitary housing.

11. The method of claim 10, further comprising:
aligning the outlet passage of the unitary housing with the inlet passageway of the further housing; and
joining the unitary housing to the further unitary housing.

12. The method of claim 11, further comprising:
connecting the inlet passageway of the unitary housing to inlet piping; and
connecting the outlet passageway of the further unitary housing to outlet piping.

13. The method of claim 3 wherein the step of forming the inlet passage way includes forming a first blind hole through one of the first and second end surfaces of the unitary housing, and a second blind hole through one of the first and second side surfaces, the first blind hole and the second blind hole intersecting to form the inlet passageway and wherein the step of forming the outlet passage way includes forming a first blind hole through one of the first and second end surfaces of the unitary housing, and a second blind hole through one of the first and second side surfaces, the first blind hole and the second blind hole intersecting to form the outlet passageway.

14. The method of claim 13 further comprising installing a plug to seal the second blind holes.

15. The method of claim 1 wherein the step of placing a valve component in the valve component opening includes:
separating the first and second housing members;
installing the valve component in the valve component opening; and
joining the first and second housing members to form the unitary housing.

16. The method of claim 1 wherein the step of forming the inlet passageway includes forming a threaded connection that is adapted and configured to connect to external piping, and wherein the step of forming the outlet passageway includes forming a threaded connection that is adapted and configured to connect to external piping.

17. The method of claim 1 wherein:
the step of forming the valve component opening includes forming a threaded connection that is adapted and configured to receive a threaded member; and
the step of placing a valve component in the valve component opening includes securing the valve component in the unitary housing with the threaded member.

18. The method of claim 1 further comprising:
forming a further valve component opening in the unitary housing, the further valve component opening being sized to receive a further valve component;
forming a secondary passageway in the unitary housing, the secondary passageway communicating with the valve component opening and the further valve component opening, wherein the outlet passageway is in communication with the valve opening via the further valve opening and the secondary passageway; and
placing a further valve component in the further valve opening.

19. The method of claim 18 wherein the step of forming the secondary passageway includes forming the secondary passageway as a blind hold through one of the first and second end surfaces of the unitary housing, further comprising installing a plug to seal the blind hole of the secondary passageway at the first and second end surfaces of the unitary housing.

20. The method of claim 1 wherein the step of providing the first housing member includes providing the first housing member as a monolithic block of material and wherein the step of providing the second housing member includes providing the second housing member as a monolithic block of material.
